(19) United States
(12) Patent Application Publication
(10) Pub. No.: US 2014/0342063 A1
(43) Pub. Date: Nov. 20, 2014

(54) Eggshell Extraction Tool

(71) Applicant: Clifford W. Heinrich, Litchfield Park, AZ (US)

(72) Inventor: Clifford W. Heinrich, Litchfield Park, AZ (US)

(21) Appl. No.: 14/306,143

(22) Filed: Jun. 16, 2014

Related U.S. Application Data
(63) Continuation-in-part of application No. 13/527,856, filed on Jun. 20, 2012, now abandoned.

(51) Int. Cl. A47J 43/28

(52) U.S. Cl. CPC A47J 43/285
USPC 426/298; 210/470

(57) ABSTRACT

An eggshell extraction utensil for selecting, isolating and removing eggshell fragments from a viscous fluid such as egg whites in a container. The utensil includes a handle, strainer portion and lip. The shape of the strainer portion is designed to maximize contact with a container edge and provide ease of use for the intended purpose. A lip extends from the strainer portion to more easily capture eggshell portions. By using the utensil, one may easily extract eggshell fragments during the preparation of certain recipes that require egg.

### PRIORITY

The present application is a continuation-in-part of application Ser. No. 13/527,856, filed Jun. 20, 2012, now pending.

### BACKGROUND OF THE INVENTION

1. Field of the Invention

This invention relates generally to culinary instruments, and more particularly to a utensil for separating chicken eggshell fragments from a viscous liquid of predominantly egg albumen and eggshell membrane.

2. Description of Related Art

Eggs are a mainstay of many diets and are prepared by cooking, baking and other food preparation methods. Eggs are primarily nutritional for the protein content, and useful due to the unique nature that egg proteins exhibit as they naturally solidify when cooked. The egg white, albumen, eggshell membrane and yolk are the primary portions of the eggs that contain health benefits of the proteins and the cooking baking benefits of transformation. Although high in calcium, the eggshell is predominantly discarded or set aside for other purposes. The egg contents are extracted by puncturing, cracking, or otherwise obliterating the eggshell. In so doing, the hard, brittle shell is often fragmented, leaving small particles in the extracted egg product liquids. In order to provide for a seamless cooking and eating experience, it is necessary to remove these eggshell fragments. The best time to do so, when the eggshells are easily identified, is immediately after extracting the egg contents.

The amateur, as well as the professional, cook or chef often faces this problem. There are various methods for removing the shell fragments, which may include manual finger-removal via poking and pincering the material. Some may use a standard kitchen tool which is not primarily intended for this purpose, and thus not properly adapted for ease and effective use. In all kitchens there are various utensils, all designed to perform different tasks, but as noted, none are designed and allow for the removal of eggshell fragments with exceptional ease.

Prior strainer-spoon utensils have utilized a strainer bottom. In combination with such strainer bottoms, these prior art strainers may use a flange acting as an upturned lip. However, a deficiency of prior art flanges arises from the origin of the shape of such flanges, which are generally adapted to fit the shape of a standard spoon bowl. This lip will not work to easily scrape the edges of various shaped containers. Some tools have been designed to include a scraping edge on a conventional spoon, and have even utilized an articulated flange body hingedly mounted to a spoon edge to overcome this deficiency. Such articulated flanges do not hold up well and are difficult to use by the average, unskilled chef.

Other skimming utensils teach a straight edge with a skimming portion. Certain egg-spatulas may be used to lift, cut, and separate cooked eggs, yet are not designed to extract eggshell fragments from as viscous liquid.

Other multi-use kitchen utensils of a similar nature utilize a spoon-like depression with a plurality of apertures, handle, and a lip/flange for cutting. This utensil is designed to have multiple uses around the kitchen, lessening the number of utensils required, but it is not designed to separate eggshells from a viscous liquid.

However, there has yet to be a tool specifically designed to easily and simply allow for the kitchen user to extract eggshells from the remainder of the egg, or other viscous liquids and/or adhering substances.

It is therefore an object of the present invention to provide an egg-shell extraction tool that is easy to use.

It is another aspect of the present invention to provide an egg-shell extraction tool that is effective in removing eggshell fragments from a viscous liquid.

It is yet another aspect of the present invention to provide an egg-shell extraction tool that can easily work with a variety of different container shapes.

It is another aspect of the present invention to provide a method for egg-shell extraction that is ergonomic for use.

It is as yet an aspect of the present invention to provide a tool to use to extract solid precipitate(s) from within a container, even if there is a viscous fluid contained therein.

These and other objects of the present invention will be understood through the detailed description of the invention below.

### BRIEF SUMMARY OF THE INVENTION

The present invention provides among other things a tool to extract eggshells from a liquid. It is an objective of this invention to provide a new utensil, and related method, that will allow a user to more easily capture eggshell fragments from a liquid.

The above and other objectives may be achieved using systems involving an egg-shell extraction tool that comprises a handle for manipulation of the tool by a user that further comprises a back end and a front end. The handle is shaped for ergonomic use to be held by a user's hand and/or fingers. The handle dips down or extends to allow for the user to put the straining surface in a container without requiring significant wrist movement. The straining surface or straining bowl is then bent back and upright to allow for ease of use. The tool may further comprise a joint at the front end of the handle where the joint or hinge connects the handle to a depressed straining surface. This articulated handle may allow for easier access to a container. The depressed straining surface may be comprised of a mesh array of perpendicularly arranged members and may include a lip adjacent to the depressed straining surface. An embodiment of the invention may include a lip extending from the mesh whereby the lip mesh interface is indistinguishable.

An embodiment of the invention may further comprise a rim surrounding the depressed straining surface, wherein at least one section of the rim is a substantially straight edge forming a defined angle along the rim.

The above and other embodiments may be achieved by using a method of extracting an eggshell from a viscous substance in a container. First, a user will take the extraction tool into one hand, and then insert the straining surface into the eggy substance. By manipulating the straining surface with a handle to capture a portion of eggshell from amidst the substance, the user can mate the straining surface with an edge of the container, and thereby withdraw the straining surface from the substance while capturing at least one eggshell portion. Upon removal from the eggy substance, the substance can be strained through at least one aperture of the straining surface, thereby isolating at least one eggshell portion.

The invention also envisions a scouper head including a unique rim shape including at least two straight edges meeting in a substantially perpendicular fashion creating a corner, giving way to a rounded edge making a somewhat rectangular/somewhat conical sectional head.

Another aspect of a preferred embodiment includes the handle dip. By allowing the handle to stay at an even position, with a descending portion, and then the head bent back to parallel or less, or further, the ergonomic function allows a user to “reach into” a container and find/capture an object without excessive wrist action.

### BRIEF DESCRIPTION OF THE SEVERAL VIEWS OF THE DRAWINGS

A more complete understanding of the present invention may be derived by referring to the detailed description when considered in connection with the following illustrative figures.

FIG. 1 depicts a perspective view of an embodiment of the present invention.

FIG. 2 depicts a top view of an embodiment of the straining surface.

FIG. 3 depicts a top view of another embodiment at the straining surface.

FIG. 4 depicts a top view of another embodiment of the straining surface.

FIG. 5 depicts a perspective view of an embodiment of the handle.

FIG. 6 depicts a perspective view of another embodiment of the handle.

FIG. 7 depicts a perspective view of another embodiment of the handle.

FIG. 8 depicts a side view of an embodiment of a portion of the handle, the joint area and the straining surface.

FIG. 9 depicts a perspective view of an embodiment of the joint between the handle and the straining surface.

FIG. 10 depicts a perspective view of another embodiment of the joint between the handle and the straining surface.

FIG. 11 depicts a perspective view of another embodiment of the joint between the handle and the straining surface.

FIG. 12 depicts a perspective view of an embodiment of the straining surface.

FIG. 13 depicts a perspective view of another embodiment of the straining surface.

FIG. 14 depicts a perspective view of another embodiment of the straining surface.

FIG. 15 depicts a side view of an embodiment of the straining surface and scraping edge.

FIG. 16 depicts a side view of another embodiment of the straining surface and scraping edge.

FIG. 17 depicts a top view of an embodiment of the straining surface and outer rim.

FIG. 18 depicts a top view of another embodiment of the straining surface and outer rim.

FIG. 19 depicts a perspective view of another embodiment of the invention.

FIG. 20 depicts a right-side view of another embodiment of the invention.

FIG. 21 depicts a left-side view of another embodiment of the invention.

FIG. 22 depicts a top view of another embodiment of the invention.

FIG. 23 depicts a bottom view of another embodiment of the invention.

FIG. 24 depicts a front view of another embodiment of the invention.

FIG. 25 depicts a back view of another embodiment of the invention.

### DETAILED DESCRIPTION OF THE INVENTION

The present application claims priority as a continuation-in-part of U.S. patent application Ser. No. 13/527,856, filed Jun. 20, 2012 and incorporates this prior application, specification, drawings, prosecution history, etc. in all parts by this reference.

The eggshell extraction tool invention may be comprised of a variety of materials. It may be comprised solely, or in combination, of wood, rubber (real or synthetic), plastic silicone, or various metals. Different materials would provide various benefits. Metals are easy to sterilize, wood maybe biodegradable, rubber can be easy to use, and plastic is easy and cheap to manufacture. Some materials may provide durability for a longer period of time than other materials that may be used for disposable invention. In the invention, the term substantially parallel means that a perfectly parallel alignment, or as close as industry-permitting, would be preferred, but may deviate from parallel by as much as +/− five degrees, and in cases with less than three members, no more than +/− ten degrees. Similarly substantially completely comprising the circumference would mean that the object, i.e. rim comprises more than 50% and preferably more than 75% of the object circumference, or as much as the entire circumference save for a portion that is needed to form a junction to reach a handle, or the entire circumference.

FIGS. 2-4 demonstrate the mesh array of straining surface 10. On the edges, top 8 or side 6, extending fingers 14a from lip 14 may be used to more easily capture small shell fragments. So as to minimize inadvertent capture of large items, such as pasta, the fingers are preferably spaced no more than 2 mm, and preferably between 0.25 mm and 0.75 mm.

In an embodiment shown in FIG. 6, the handle is flat and rectangular from the back end to the front end. This configuration is easy to manufacture. Alternatively, the handle may be tapered, as shown in FIG. 7, so that the back end is wider than the front end. This configuration may be more ergonomic.

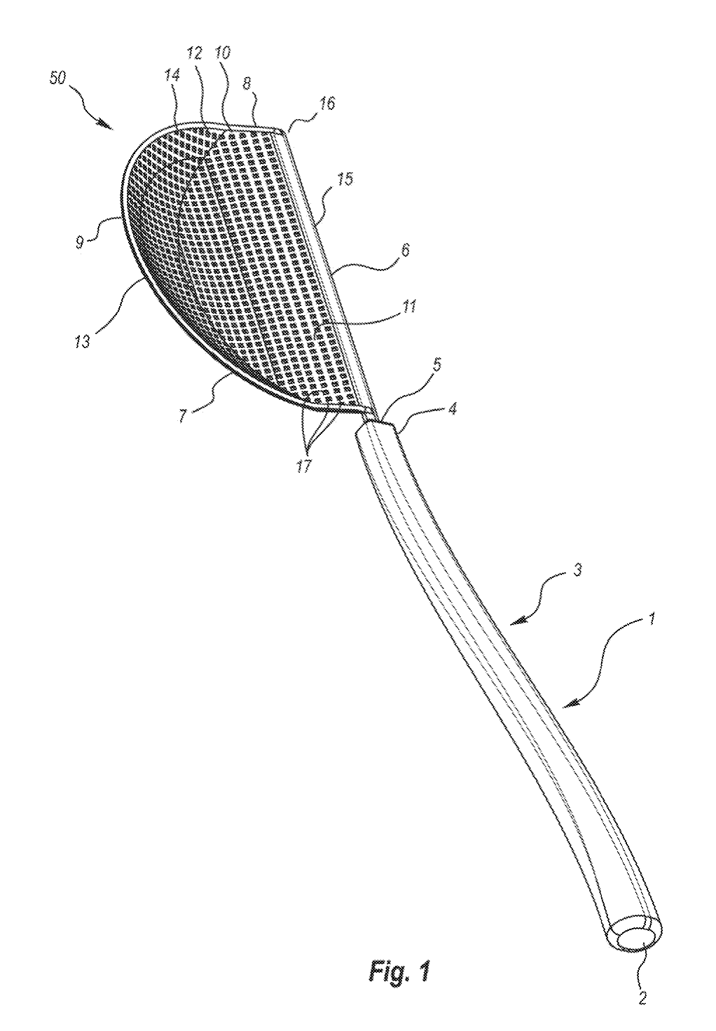

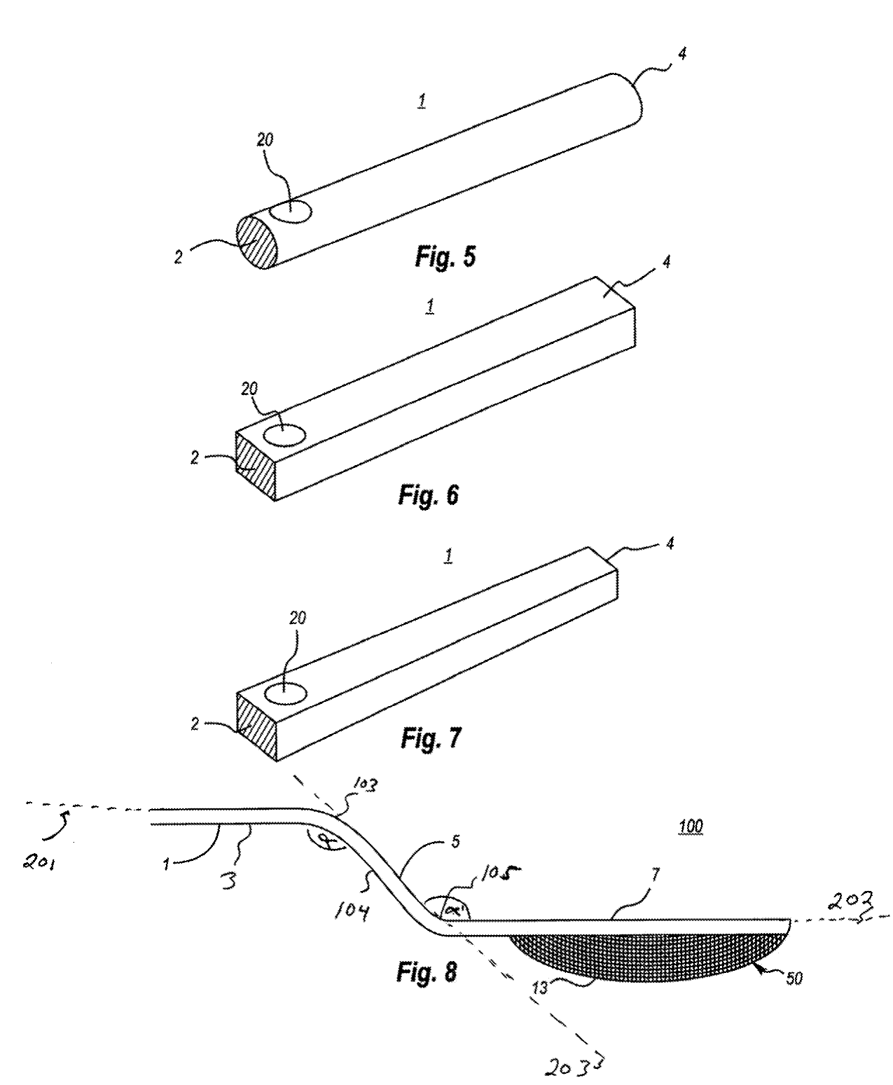

In an embodiment shown in FIG. 5, the handle may be rounded, similar to a dowel, so that the handle is one cylinder from the front end to the back end. As in FIG. 1, this cylinder may also be tapered so that the back end is thicker than the front end.

In an embodiment shown in FIG. 10, the handle is formed of at least one wire so that the handle is a wire-frame. The wire may be of wood, plastic, rubber (real or synthetic), and/or metal. This wire-frame configuration may be easy to manufacture and easy for a user to utilize. In an embodiment shown in FIG. 5, the handle includes a hole completely through it, which is substantially near the back end so that the invention may be hung from a hook. This allows for easy storage and access.

The handle may be any length, with different lengths useful for slightly different purposes and containers.

In an embodiment shown in FIG. 8, the handle is comprised of multiple pieces. This configuration may be easy to manufacture. It could also allow the invention to be foldable, so that it is easier to store and use.

In an embodiment shown in FIG. 8, handle 1 has multiple curves. This configuration may be more ergonomic and easier to use than some other configurations allowing a user to grip grip portion 3 and insert scouper 50 into a container without the need to bend at the wrist. It may also allow the tool to reach into places and containers that would not be possible in some other configurations. Grip portion 3 tends towards back end of handle 1. Grip portion 3 defines a grip plane 201. At some point along handle, juncture 103 provides a dip by offsetting descending neck 104 at an angle of preferable thirty degrees from grip plane 201. Descending neck dip angle α defines dip plane 203.

The angle α may range between twenty and ninety degrees, depending on user preference, type of containers used, or size of tool. Smaller angles between twenty and thirty degrees work best with larger sized tools, whereas deeper angles greater than forty degrees work for smaller sized tools. Industrial applications with severely large tools and containers may call for degrees offset by as much as ninety degrees. Descending neck 104 leads forwards to juncture 105 with scouper portion 50. Juncture should create a correcting angle α′ which is preferable of same intensity and reverse of angle α so as to allow scouper top plane 202 to be parallel with grip plane 201. Some differentiation between α and α′ may be preferred, again depending on the angle α and size of tool, whereby sometimes α′ may be more or less up to twenty degrees more or less than α.

In an embodiment shown in FIG. 8, the handle may be placed at a positive or negative angle relative to line extended from the bottom of the depressed portion. The handle may be substantially parallel to this line. These various configurations may help the user utilize the tool efficiently. It may be possible that the handle can be adjusted for various angles for various users and uses.

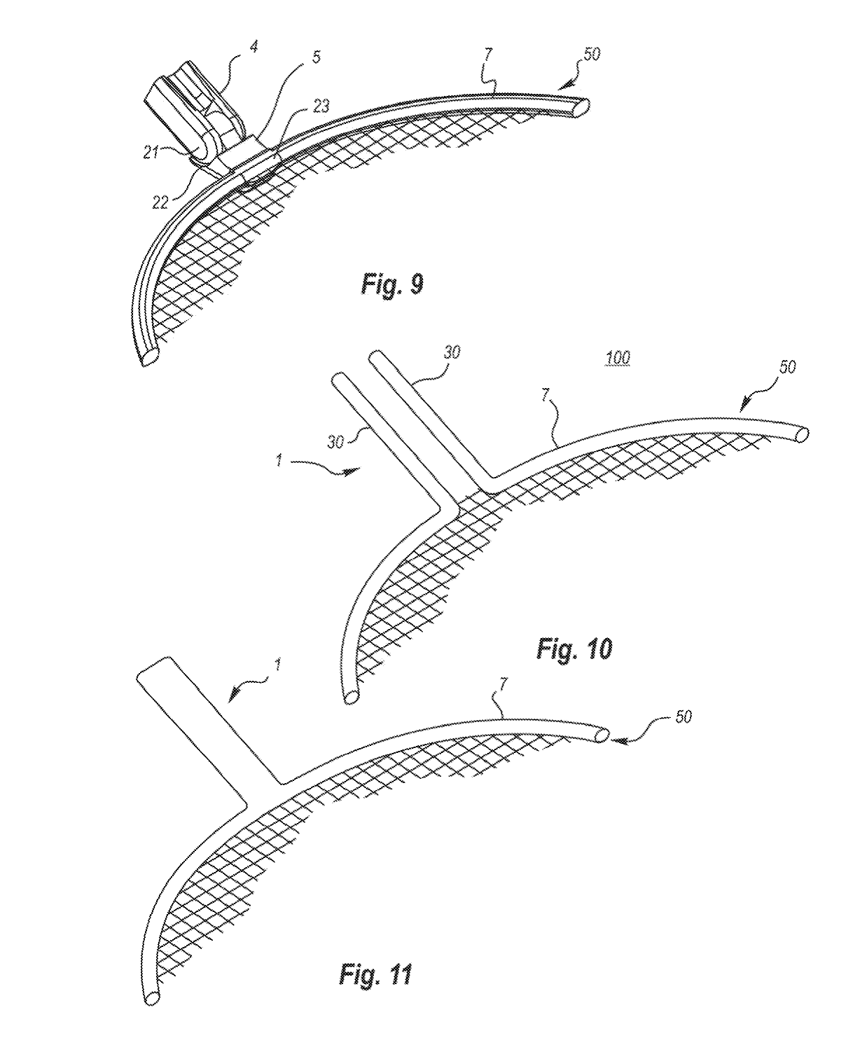

In many embodiments (sonic may be seen in FIG. 1, FIGS. 9-11), the handle is connected to the straining surface through some type of joint located substantially near the front end of the handle. The joint may be any type of screw, nail, glue, or any other type of fastener. It may be that there is no separate joint and the handle and straining surface end are manufactured partially out of one connected piece of material. The joint may be made out of the same or different material than the handle and/or straining surface.

In an embodiment shown in FIG. 9, the joint is movable and/or adjustable so that the angle of the straining surface can be adjusted. The angle may be adjusted in all directions limited example, front-to-back, and/or side-to-side).

The joint maybe removable, whether it be a tongue-and-groove configuration or some other. This joint may be permanent or temporary. It may be easy to take apart so that the invention can be more easily stored and/or more easily cleaned.

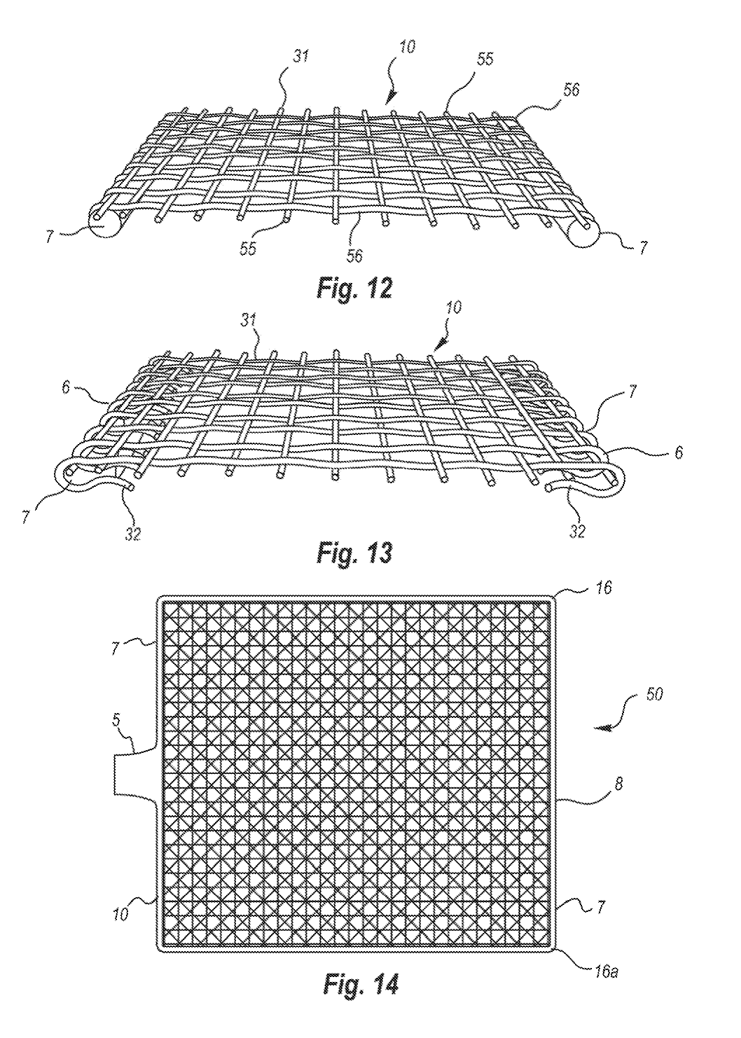

The straining surface attached to the handle may have many different embodiments. Some of these embodiments are shown in FIGS. 1-4, and FIGS. 9-18, and are detailed below. In an embodiment shown in FIG. 9, the straining surface attached to the handle may be at an angle between −45 and 60 degrees from a plane that is substantially parallel to the handle.

In an embodiment shown in FIG. 2, the straining surface is comprised of an outer rim and a mesh attached to the outer rim forming a depressed straining surface. This outer rim may be comprised of a single component or of multiple components. The outer rim may be comprised of the mesh itself, by having a portion of the mesh substantially near the edge of the straining surface folded over itself so that there is a distinct end of the straining surface where the mesh is thicker than in the majority of the surface. The outer rim may be thick or it may be thin. The outer rim may comprise a substantial amount of the straining surface or it may be comprised of the straining mesh itself. The outer rim may be flat, rectangular, triangular, and/or rounded. The outer rim may form rounded, as shown in FIG. 17, or sharp, as shown in FIG. 18, corners. There may be no defined corners so that the utensil has a conventional spoon shape.

In an embodiment shown in FIG. 2, the outer rim forms a scraping edge on one or more sides of the straining surface so that a user may scrape the edges of a container in order to capture as many eggshell fragments as possible. This scraping edge, or lip, may extend substantially past the outer rim. The scraping edge(s) may be angled to form a better scraping utensil.

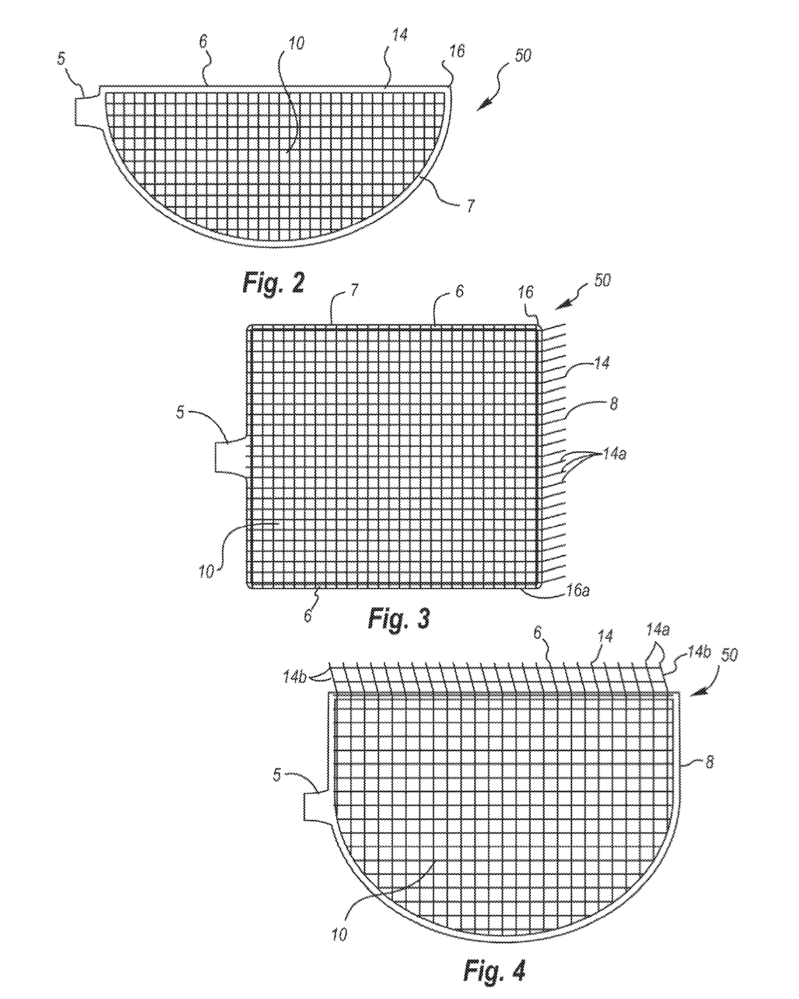

In an embodiment, the shape of the outer rim is similar to that of a spoon as it is elliptical in shape. In another embodiment as seen in FIG. 3, the straining surface may be substantially rectangular or quadrilateral in shape. In other embodiments as seen in FIG. 4, the straining surface may have a substantially straight edge on at least one particular side and rounded edges on the remaining sides. This substantially straight edge may be located on any side of the straining surface besides the side where the handle is located. The substantially straight edge may be located on a side substantially parallel to the handle or it may be located on the side substantially perpendicular to the handle. The side substantially perpendicular to the handle is the front end of the straining surface.

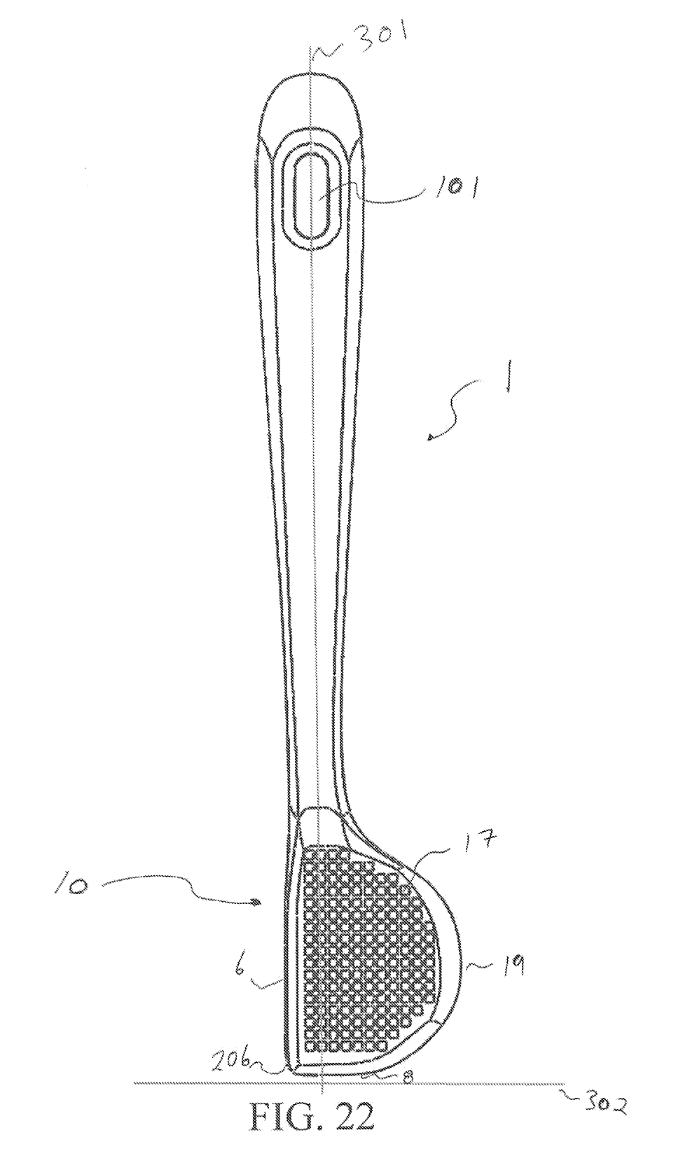

As shown in FIG. 22, side edge 6 may be parallel to longitudinal axis 301 defining the center of the handle body. Perpendicular to longitudinal axis is perpendicular axis 302. A portion of top edge 8 may align with perpendicular axis 302. Curved portion 19 may run out of and adjacent to top edge 8, while curving back around to complete the circumference of lip 7, and adjoin to joint 5 and/or base 4. Thus the shape of the scouper portion 50 rim 7 can include a first extending straight side edge 6, a right angle at 206 adjoining side edge 6 and to edge 8, whereby top edge 8, extending at least 2 mm, preferably 10 mm, before flowing into curved portion 19 of rim to run back to handle 1.

In an embodiment shown in FIG. 1, the mesh is comprised of the same material as the handle. This material may be wood, metal, rubber (real or synthetic), a plastic, or any combination. The mesh may be attached to the outer rim by a glue, it may be folded over the outer rim and connected to itself, it may be welded to the outer rim, or it may be attached in any other way that will allow the mesh to stay connected to the straining surface end of the utensil. By incorporating the same material as the handle for apertures 17, for instance of plastic or metal, the size of the apertures may be expanded. As shown in FIG. 22, the area encompassed by apertures 17 greatly exceeds the solid portion area of straining surface 10.

As shown in FIG. 22, handle 1 may include hanging slot 101 to allow the handle to be hung on a hook, etc.

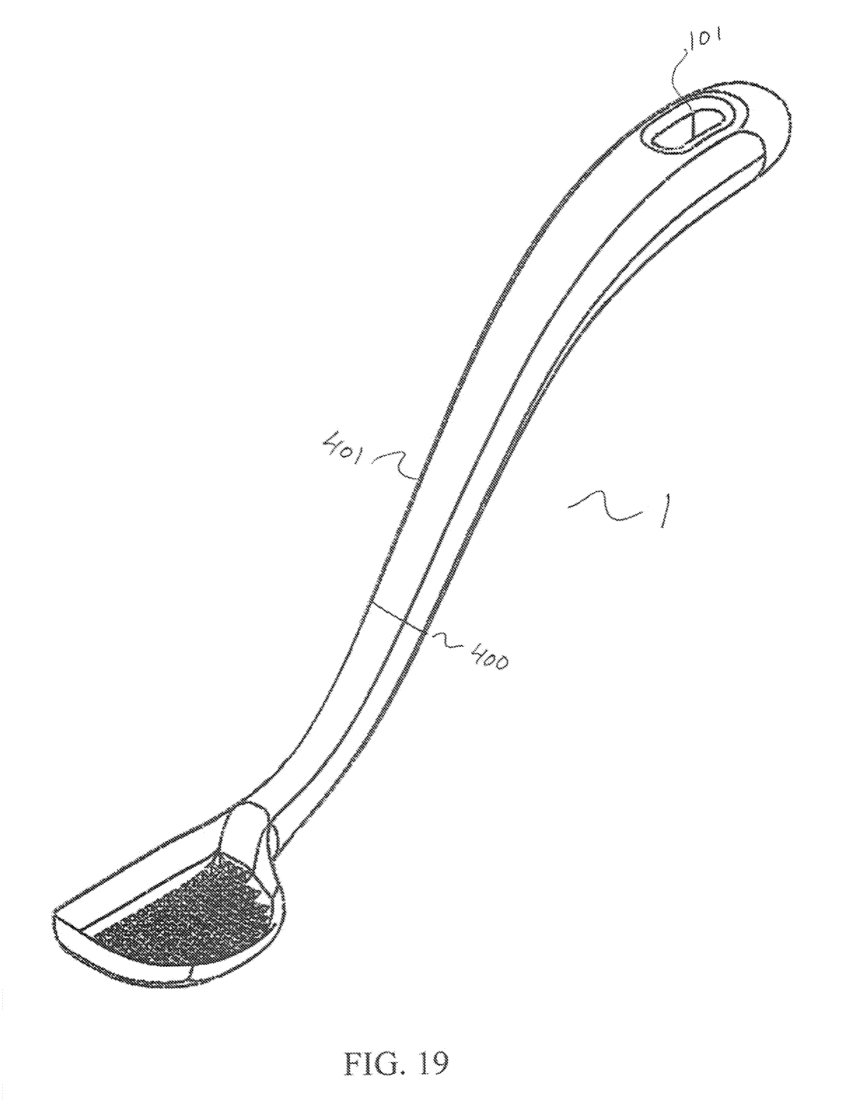

In the preferred embodiment as shown in FIG. 19, the core base of the tool would be made of a solid material, i.e. metal such as aluminum for strength and light weight. At indentation (not shown) at 400, a gripping handle material 401, preferably a thermoplastic elastomer such as SANTOPRENE™ for friction is placed over a metal core to allow for greater grip. In an alternative embodiment, the entire tool may be made of a metal, or a single plastic extruded, blown, injected or printed piece.

FIG. 19 demonstrates the tool in a right-handed mode, whereby side edge 6 is on the right side to allow a right-handed person to directly press and hold a piece of egg shell fragment with ease. The tool can be made in reverse, with the scouper head re-arranged for a left-handed individual.

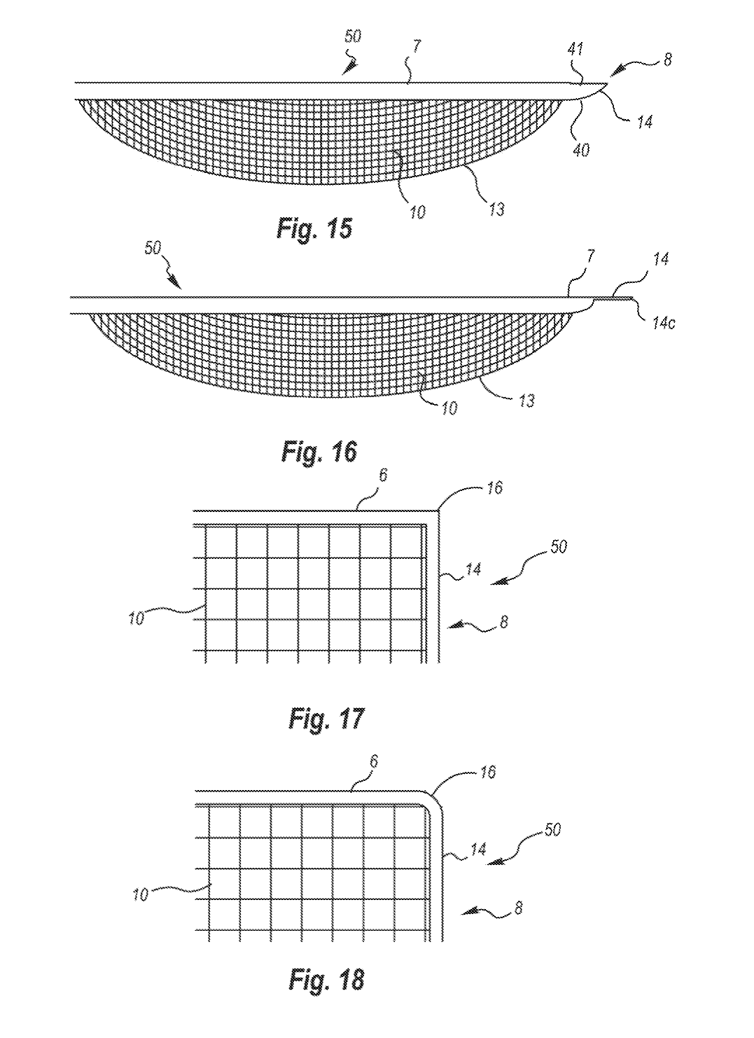

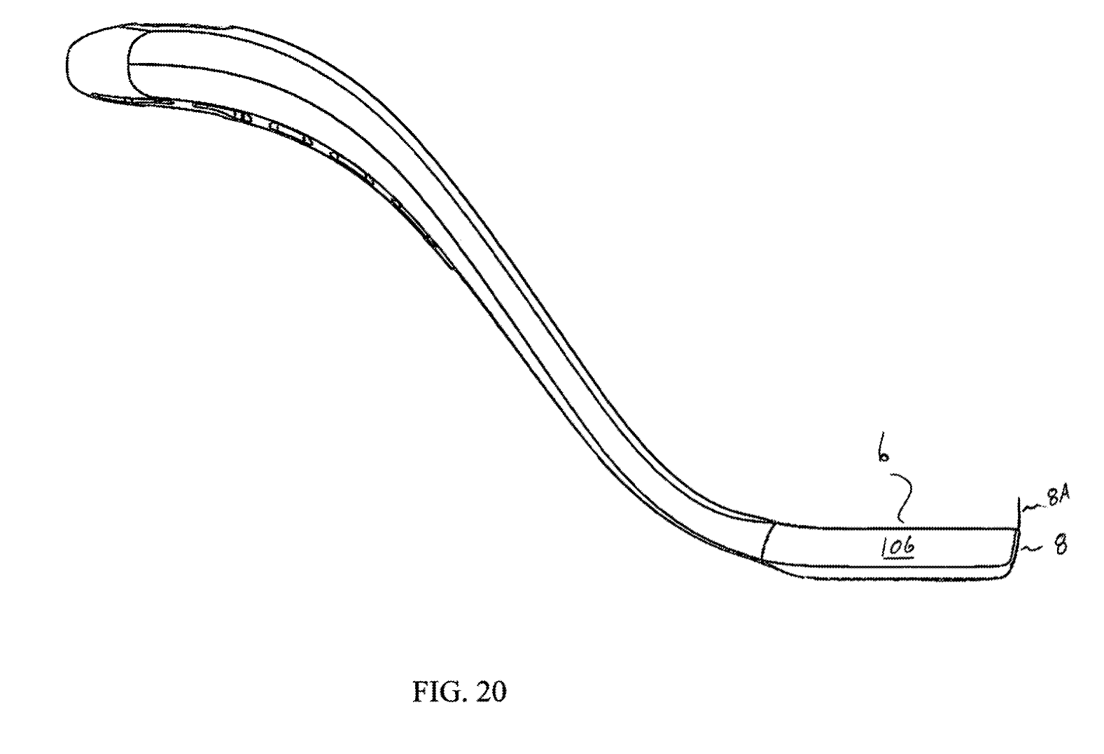

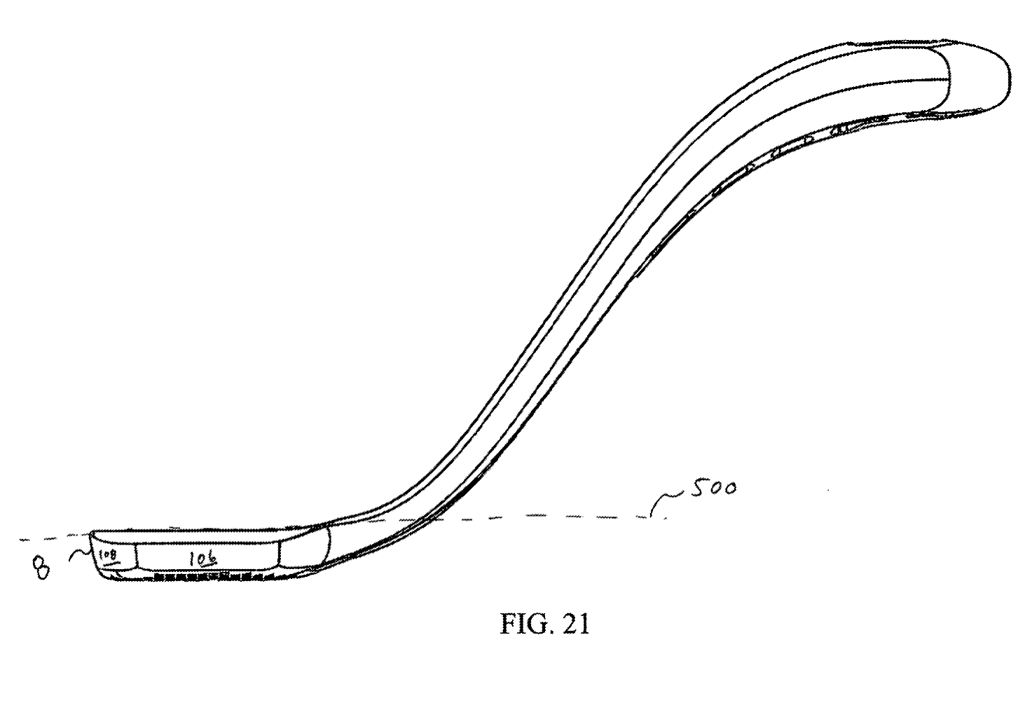

As shown in FIG. 20 and FIG. 21, side edge 6 may encompass a vertical wall 106, whereby the lip extends upwards at 90 degrees from the top plane. Top edge 8 may encompass a vertical wall 108, whereby the lip extends upwards at 90 degrees from the top plane 500. Top edge 8 may also extend vertically, and extend beyond lip at 8A. In an alternative embodiment the lip may extend horizontally as shown in FIG. 15 or FIG. 16.

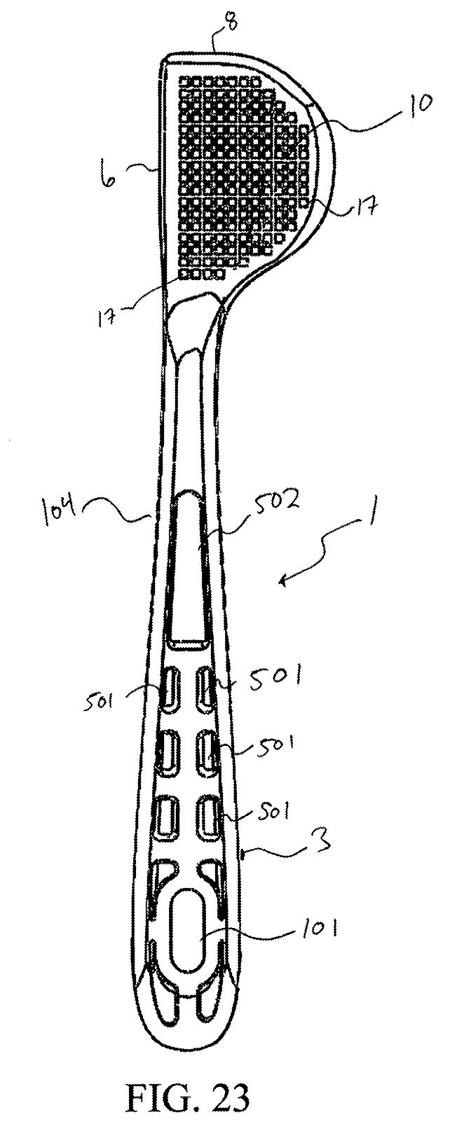

As shown in FIG. 23, handle 1 may include indentations 501 to provide for better grip and ergonomic comfort. Surface 10 may include a plurality of apertures 17. Preferably, indentation 501 are symmetrically included in pairs. Most indentures will preferably appear on grip portion 3, whereas an additional indentation 502 may be included along descending neck 104 for thumb or forefinger grip. Additionally, indentation 502 provides for as cavity that will lighten the overall weight and cost of manufacture.

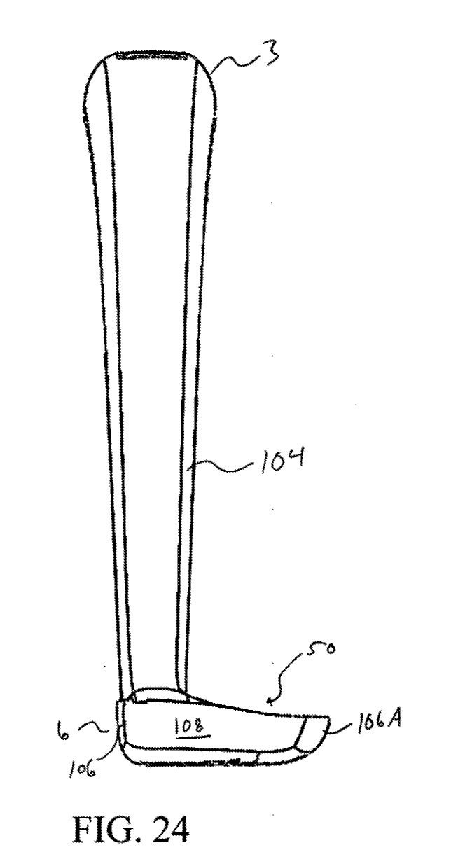

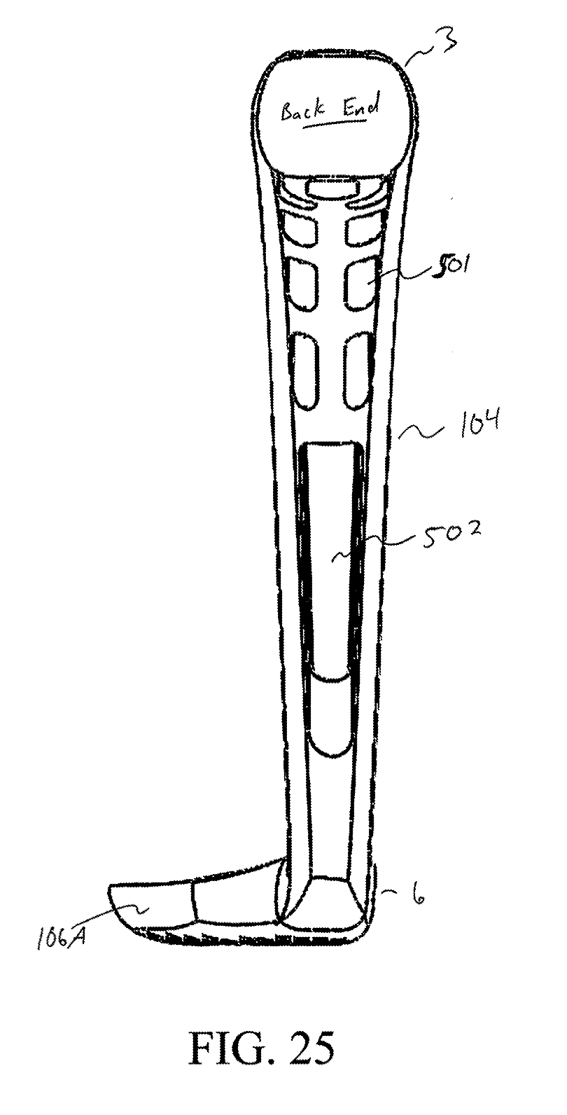

As shown in FIG. 24, scouper may contain vertical wall 108 at top edge and 106 at side edge alongside edge 6. Opposite side edge 6 is the preferably the curing portion of scouper head 50 off of descending neck 104, following remainder of head 50 circumference to complete lip 7 for a complete bowl shape with two solid flat sides and a completing third wall 106A. In this image, the majority of grip 3 is hidden. As shown in FIG. 25, back end butts grip 3, adorned with indentations 501 and descending neck 104 includes indentation 502. Opposite side edge 6, side edge wall 106 may be less than perfect vertical sloping to allow for scraping against the wall of a concave bowl. The right angle of scouper head 50 is primarily meant to scrape against the interior corner of a storage container.

I claim:

1. An eggshell extraction tool for extracting an eggshell fragment from an interior surface of a container, said extraction tool comprising:
a handle for manipulation of the tool by a user, said handle comprising a back end and a front end;
an ergonomic gripping portion along said handle adjacent to said back end for gripping the tool, said gripping portion defining a gripping plane;
a descending neck angled between twenty-degrees and ninety-degrees off of said gripping plane, whereby a sloping junction joins said gripping portion and said descending neck;
a second junction joining said descending neck to a capture bowl;
said capture howl having a rim defining a top plane;
whereby said second junction comprises a negative angle between said descending neck and said capture bowl, said negative angle sufficient to counter-effect said sloping junction so as to arrange the top plane substantially parallel to said gripping plane;
said capture bowl comprising a straining surface;
said rim comprising a substantial portion of said capture bowl circumference; and
said rim arranged for mating with the surface of the container.

2. The eggshell extraction tool of claim 1 whereby at least one section of said rim comprises a vertical raised lip forming right angle offset from said top plane.

3. The eggshell extraction tool of claim 1 whereby at least one section of said rim comprises a horizontal extended lip substantially parallel to said top plane.

4. The eggshell extraction tool of claim 1 wherein said straining surface comprises a mesh.

5. The eggshell extraction tool of claim 4 wherein said straining surface comprises a mesh array of substantially perpendicularly arranged members, wherein at least one of said perpendicularly arranged members extends beyond said rim.

6. The eggshell extraction tool of claim 1 whereby said straining surface forms a convex bowl depressed below said to plane.

7. The eggshell extraction tool of claim 1 whereby said gripping portion defines a longitudinal grip axis in said gripping plane; and whereby said rim of said capture bowl is shaped to form a top edge which is perpendicular to said longitudinal grip axis.

8. The eggshell extraction tool of claim 7 whereby the circumference of said capture bowl is shaped to form a side edge adjacent to said top edge which is parallel to said longitudinal grip axis, thereby forming a right angle with said top edge.

9. The eggshell extraction tool of claim 8 whereby the circumference of said capture bowl is shaped to form a curved portion adjacent to said top edge; said curved portion said curved section adjacent to and joining said second junction.

10. The eggshell extraction tool of claim 1 whereby said gripping portion defines a longitudinal grip axis in said gripping plane; and whereby the circumference of said capture bowl is shaped to form a top edge which is parallel to said longitudinal grip axis.

11. A method of extracting an eggshell from a viscous substance held in to container, comprising the steps of:
gripping an extraction tool into one hand, the extraction tool having a handle, a straining surface comprising at least one aperture, and a straining surface edge;
whereby the step of gripping comprises gripping the extraction tool by the handle;
inserting at least a portion of the straining surface into the substance;
manipulating a relative location of the straining surface in order to capture at least a portion of the eggshell from amidst the substance;
mating the straining surface edge with as first interior wall of the container; withdrawing the straining surface from the substance whilst capturing the at least portion of the eggshell on the straining surface; and
straining the substance through the at least one aperture of the straining surface, isolating the at least portion of the eggshell.

12. The method of claim 11 whereby said step of mating comprises mating a first edge of said straining surface with a first interior edge of the container, while mating a second edge of said straining surface to a second interior edge of the container, said first and second straining surface edges adjacent to one another and angled in relation to one another forming a corner for mating with a container having multiple planar containing surfaces.

13. The method of claim 11 whereby the step of manipulating further comprises capturing at least a portion of the eggshell against the interior wall of the container.

14. An eggshell extraction tool for extracting an eggshell fragment from an interior surface of a container, said extraction tool comprising:
a handle for manipulation of the tool by a user;
a straining surface comprised of a mesh array of substantially perpendicularly arranged members; and
a lip adjacent to straining surface forming a structural support of said straining surface;
whereby said mesh array comprises substantially parallel extending members separated from one another by less than 0.75 mm, said extending members extending beyond said lip to form fingers.

15. The eggshell extraction tool of claim 14, wherein said extending members are arranged for mating with the surface of the container.

16. The eggshell extraction tool of claim 14, wherein said extending members are separated from one another by less than 0.50 mm.

17. The eggshell extraction tool of claim 14, wherein said extending, members are separated from one another by 0.25 mm.
